(19) United States
(12) Patent Application Publication
(10) Pub. No.: US 2003/0095510 A1
(43) Pub. Date: May 22, 2003

(54) Use and management of groups defined according to a call initiation protocol

(75) Inventor: Jheroen Pieter Dorenbsoch, Paradise, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 09/990,929

(22) Filed: Nov. 16, 2001

(51) Int. Cl. H04L 12/16; H04Q 11/00

(52) U.S. Cl. 370/260; 455/433

(57) ABSTRACT

A method of independently managing membership for a group and mobility for members of that group in a communications system includes setting up a group name and a membership for that group including a plurality of names, each of the names indicative of a user within that group; and establishing, separately from the membership, contact information associated with each name. With this method, initiating a session with members of a group includes contacting a first registrar with a request for a session, that registrar including the names indicative of the members of the group and a further registrar associated with each of the names; forwarding the request for a session to the further register that includes contact or end point info for the member; and then forwarding the request to the contact associated with the member.

### FIELD OF THE INVENTION

The present invention relates to communications systems and more specifically to such systems that provide for establishing communications amongst a group according to a call initiation protocol within the system.

### BACKGROUND OF THE INVENTION

Communications systems are known and such systems normally use some form of call initiation protocol. One such protocol is a session initiation protocol (SIP) and systems utilizing SIP have been contemplated. SIP is a general purpose protocol that aids in setting up communications between users or a group of users where the communications may use or require certain multimedia facilities or services (voice, video, etc.). SIP is a protocol that has or is being defined by the Internet Engineering Task Force (IETF). The basic specification for SIP may be obtained through the IETF website and is identified as draft-ietf-sip-rfc2543bis. Various other documents related to SIP are available through the same site.

According to the SIP specification to make a group requires defining a SIP name for the group such as sip:group1@domainB.net or org or etc (hereafter denoted domainB). This name includes a user part and a domain part, here group1 and domainb respectively. The server or registrar for domain B is now responsible for handling the mobility of each of the members of group 1. Mobility of a SIP group is handled like that of a normal SIP user. Basically the registrar of the responsible domain keeps one or more contacts or locations for each member or user that is a part of the group. For example, if user1 was a member of group1 and normally available or located at host1 in domainA the contact under SIP could be of the form user1@host1.domainA.

When a caller wishes to contact group1 a SIP INVITE message is sent to domain B and the registrar of domain B forwards or redirects the INVITE message to each of the contacts it keeps for each of the members of this group. Mobility is handled under SIP with REGISTER messages. In known systems using SIP, when a user moves locations the user must send a REGISTER message to its own domain as well as the registrar of each group where it is a member. Various problems are evident with this approach. Each user must know all groups where it is a member and when this membership is large a large number of registration messages are required when the user moves locations. This requires extreme discipline on the part of users and the large number of registration messages can be expensive particularly in an environment such as wireless where bandwidth may be limited. Clearly a need exists for an improved methods and apparatus for using and managing group membership and mobility defined according to various call initiation protocols.

### BRIEF DESCRIPTION OF THE DRAWINGS

The accompanying figures, where like reference numerals refer to identical or functionally similar elements throughout the separate views and which are incorporated in and form part of the specification, serve to further illustrate various embodiments in accordance with the present invention. The figures together with the detailed description, hereinafter below, serve to explain various principles and advantages in accordance with the present invention.

FIG. 1 depicts, in a simplified and representative form, a block diagram of a communications system and prior art group management practices;

FIG. 2 depicts, in a simplified and representative form, a communications system utilizing an embodiment of group definition according to the present invention;

FIG. 3 illustrates in a simplified and representative form a communications system using an embodiment of group management in accordance with the present invention to facilitate setting up a conference call;

FIG. 4 depicts the FIG. 3 system session routing after the conference call has been set up; and

FIG. 5 depicts a flow chart of a method embodiment of setting up a conference call in accordance with the present invention.

### DETAILED DESCRIPTION OF THE PREFERRED EMBODIMENT

In overview form the present disclosure concerns communications systems that provide service to communications units or more specifically user thereof operating therein. More particularly various inventive concepts and principles embodied in methods and apparatus for the use and management of groups of such users are discussed, the groups being defined according to various call initiation protocols. The communications systems of particular interest are those being deployed such as GPRS systems or those being planned that employ IPv6 such as 3^{rd} generation IP based systems or other systems using IP addressing and allowing for mobility of the communications services users.

As further discussed below various inventive principles and combinations thereof are advantageously employed to essentially decouple group membership and the location or contact information (mobility) for the various members, thus alleviating various problems associated with known systems while still facilitating setting up sessions with or between groups of users regardless of present locations provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

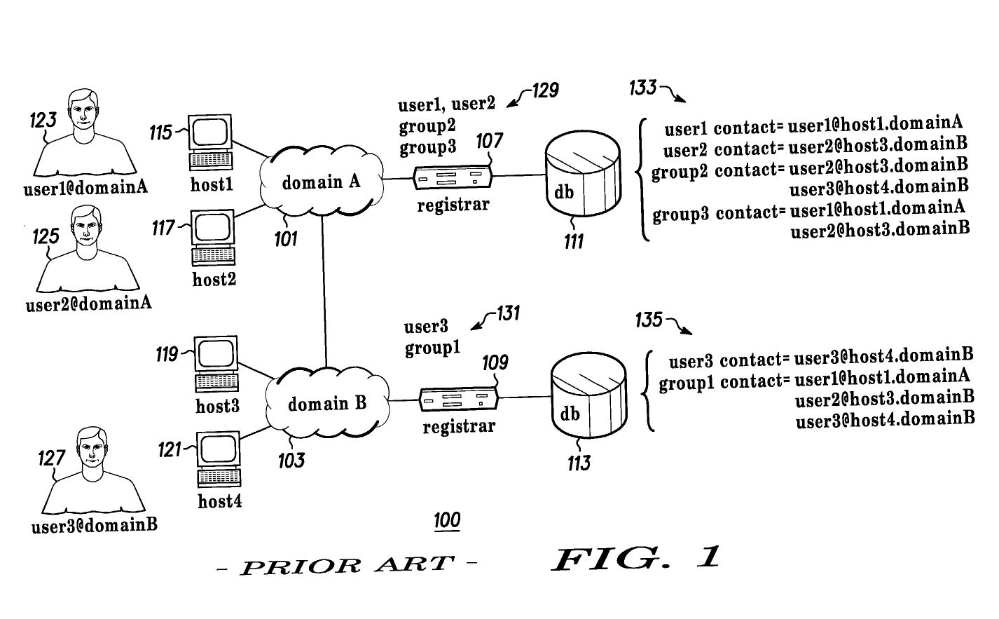

The present disclosure will discuss various embodiments in accordance with the invention. These embodiments include methods for managing membership and mobility for a group of users, initiating a session, and methods of setting up a conference call using or employing each or all of the aforesaid. The system diagram of FIG. 1 will be used to more fully explain a prior art system of group management and resultant problems, to develop common language conventions and thus to lay the groundwork for a deeper understanding of the present invention and advantages thereof. FIG. 1 in large part and at the simplified level depicted is a representative block diagram of the relevant portions of a communications system 100, for example, a typical and known internet communications system or future such systems that may be any combination of wired or wireless systems.

The system 100 is a wide area network (WAN) comprised of various interconnected domains such as domain A 101, domain B 103, etc. The exemplary system of FIG. 1 as depicted will be explained in terms of such a system operating according to the Session Initiation Protocol (SIP) for call set up purposes. SIP is a typical call setup protocol particularly adapted for IP based networks. The domain A has a registrar 107, such as a SIP registrar and the domain B has a registrar 109, such as a SIP registrar each of which operate to keep one or more contacts in database 111, 113, respectively, for users registered with or under its domain and, according to SIP, one or more contacts for each member of any group with a name that indicates it is under the purview of that registrar. The registrar can be a server operating in accordance with appropriate protocols. For example, a SIP registrar would operate according to the SIP protocol with respect to call setup procedures. To review, a user name or group name under SIP is of the form sip:user1@domainA and sip:group2@domainA, respectively, whereas a user contact is of the form sip:user1@host1.domainA (Note: hereafter the “sip:” will be dropped in the interest of generality and simplicity. It is understood that “sip:” is part of a SIP user or group or contact designation). The contact resolves the location of a user to a communications unit whereas a name does not and in the case of SIP merely resolves the domain or registrar where such information or information leading to such information may be found. Returning to FIG. 1, each domain serves or provides connectivity and services to a plurality of hosts such as host1 115 and host2 117 for domainA and host3 and host4 for domainB. The hosts are at least logical communications units, namely an IP address for a particular name and usually a physical device or communications unit such as a desk or lap top computer. However a user with a wireless device such as a PDA or laptop or cellular phone device may connect to domainA and be host2 when so doing or alternatively may connect to domainB and be logical host3 in that instance. A plurality of users with names such as user1@domainA 123, user2@domainA 125, and user3@domainB 127 are served by the registrars 107, 109 and while normally located logically at a particular host are mobile or free to roam about the system 100.

FIG. 1 also depicts together with each registrar those users and groups that are registered with each registrar, specifically user1, user2, group2 and group3 129 for registrar 107 and user3 and group1 131 for registrar 109. Furthermore database 111 includes a contact or contact information for each of user1, user2, group2 and group3 133 and database 113 includes a contact or location for each of user3 and group1 135. For example by observation, the contact or location for user1 is user1@host1.domainA and for user2 is user2@host3.domainB. For a group whose name is, for example, group2@domainA there is contact information for each member of the group. In FIG. 1 this includes user2 and user3 for group2, user1 and user2 for group3, and user1, user2, and user3 for group1.

The contact or location information is placed in the database and updated using a SIP REGISTRER message originated typically by the user. REGISTER messages are the process used according to SIP that manages mobility for the respective users. For example, after user2 changes location from host3 to a new host, for example, host2, the user or the new host must send a sip REGISTER message that in form may look like REGISTER user2@domainA. Typically the message also contain a contact or end point header that specifies the new location where the user2 can be reached, specifically user2@host2.domainA, and an indication that the previous contact is no longer valid. According to the SIP protocol, user2's REGIST?ER message is forwarded to the registrar 107 of domainA. Registrar 107 would change the contact for user2 from user2@host3.domainB to user2@host2.domainA. Repeating, these registration messages are the process by which SIP manages mobility for the users and many call setup protocols have analogous procedures.

In operation if user1 wishes to set up a call or session with user3, user1sends, in SIP protocol, a SIP INVITE message to user3 which in form may look like INVITE user3@domainB from user1@domainA[IPaddress_port#]. According to the SIP protocol user1's message is forwarded to domainA 101 and from there to the specified domain for user3, namely domainB or registrar 109. Registrar 109 has contact or a location within its database for user3, specifically user3@host4.domainB and forwards the INVITE message to user3 at host4. By way of example a representative but simple INVITE message from Alice to Bob was copied from draft-ietf-sip-rfc2543bis-05 and is included below. One line to note is the Via line and that includes the IP address, 10.1.2.3, and port #, 5060, at which Alice expects to receive a reply from Bob The reader is referred to the full document for further interpretation. The document is hereby incorporated herein in its entirety by reference.

INVITE sip:bob@biloxi.com SIP/2.0

Via: SIP/2.0/UDP 10.1.3.3:5060

To: Bob <sip:bob@biloxi.com>

From: Alice <sip:aliceaatlanta.com>;tag=1928301774

Call-ID: a84b4c76e6G710@10.1.3.3

CSeq: 314159 INVITE

Contact: <sip:alice@10.1.3.3>

Content-Type: application/sdp

An INVITE to group3 from user3 would be of the form sip INVITE group3@domainA from user3@domainB[IP_Port}. This message would be forwarded to domainA or registrar 107 and registrar 107 would forward the message to each contact for the membership of group3, specifically user1@host1.domainA and user2@host3.domainB. One problem with this approach to group management is the large number of registration messages that the system must support when a user, such as user2 with the name user2@domainA chooses to move from host 3 in domainB back to host2 in domainA. This user will have to send a registration message to its own or home registrar plus a registration message to each registrar that is servicing each group where the user is a member. In this simple example when user2 moves at least four registration messages will need to be generated, one for its own registrar and one each for the respective registrar for each of 3 groups. Furthermore user2, whomever, or whatever is charged with the registration updates will need to know every group where user2 is a member.

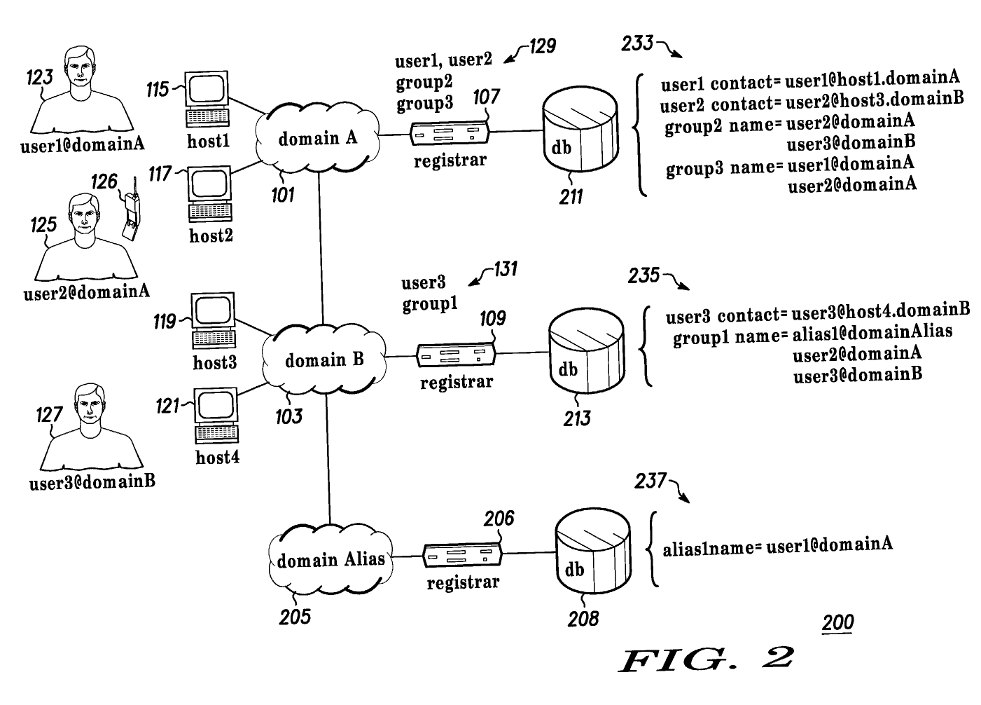

Referring to the FIG. 2 depiction, of a simplified and representative communications system 200 we will describe an inventive embodiment, according to the present invention, of group definition and management that resolves the aforementioned problems. FIG. 2 in large part resembles FIG. 1 where like reference numerals refer to like items. This system is intended to operate with most general purpose call setup or initiation protocols but will be described with reference to SIP conventions for naming and call routing. The database 211 associated with registrar 107 is different and includes different contents. The database still includes contact or location information for users that are registered with domainA but only contains names of members of the groups registered with domainA. Specifically contacts and names for, respectively, user1, user2 and group 2, group3 233 are maintained. The database 213 for registrar 109 is likewise different including contacts for users registered with domainB but only names of members for groups registered with domainB. Specifically contacts and names for, respectively, user3 and group1 235 are stored and maintained.

With this approach to group definition and management an INVITE from user1 to group2 would go to registrar 107 and be forwarded to the names of the members of group2. Specifically user2@domainA would be resolved by registrar 107 to the contact or location user2@host3.domainB and forwarded to user2 on host3 while user3@domainB would be forwarded to registrar 109 and resolved by that registrar to the contact or location or end point user3@host4.domainB and the INVITE would thus be forwarded to user3 at host4.

A further difference is that one of the names of a member of group3 is alias1@domainAlias. By the rules of the SIP protocol an INVITE directed to group1@domainB will be forwarded to alias1@domainAlias. FIG. 2 depicts a domainAlias 205, interconnected with domainB and domainA, with a registrar 206 and database 208. The database includes a name for alias1 237 that is user1@domainA. Thus an invite directed to alias1 would be redirected to the name user1@domainA and there be resolved by the registrar 206 to a contact or location of user1@host1.domainA and thus forwarded to user1 at host1.

This approach to group definition and management allows for independently managing membership for a group and mobility for members of that group in the communications system of FIG. 2. This method includes setting up a group name and a membership for that group including a plurality of names, each of the plurality of names indicative of a member or user within that group. This is accomplished, for example, in a SIP compatible system by sending a REGISTER message indicating the name and domain of the group, such as group1@domainB. The REGISTER message would also include a Contact header specifying the names of the members of group3, specifically alias1@domainAlias, user2@domainA, and user3@domainB. Alternatively three RESISTER messages, one each for each member of the group could be sent with appropriate contact information for one of the members.

Having set up the names for members of the group then establish separately and independently from the group membership contact or location information associated with each of the plurality of names for the membership. In a SIP compatible system a REGISTER message to the respective domains can specify a contact such as user2@host3.domainB, user3@host4.domainB, or another name such as user1@domainA. In the last case a REGISTER message would need to be sent to domainA with the contact user1@host1.domainA in order to assure that messages for user1 domainA can be routed to the proper end point or location. This method of setting up the membership including the plurality of names advantageously uses a name indicative of the user that points or leads one to a domain or registrar, for example sip:user1@domainA where a contact for the user or member will be found. As noted above an alias name can be used for a member or user. Note that this method of setting up the membership allows for the users to manage their mobility of for a third party to manage the membership.

Also note that this method of defining and managing groups allows or provides for changing contact information without a corresponding change in membership information. By establishing the contact information as noted above a change to the contact information, specifically that portion providing for resolution to an end point or location, does not require a corresponding change to the membership information. By observation suppose user2 carrying wireless device 126 roams or moves from the locality of domainB at host3 to domainA at host 2. One REGSTRATION message changes the contact information at domainA to user2@host2.domainA and that is all that is required. No membership lists need to be changed. A user or member no longer needs to know the groups where they are a member. The registration load on the system is dropped to 25% of the load in the prior art system of FIG. 1. In the real world it is not uncommon for a user to be a member of 10s and hundreds of groups so the actual savings in registration load is likely orders of magnitude larger than here described. Furthermore by always using the alias approach a user can change domains or service providers say from domainA to domainB and only have to send one REGISTER message to domainAlias rather than one for each group plus the service provider domain. The downside of the alias approach is perhaps somewhat longer call setup times as one extra communications link will be involved.

To review suppose a userN@domainZ (not shown) wishes to use a call initiation protocol, such as SIP for initiating a session with members of a group, such as group1. UserX would contact a first registrar, here registrar 109 of domainB with a request for a session with group1, using, for example, an INVITE message defined according to SIP. This registrar will include a plurality of names, each of the names indicative of a member of the group and a second registrar associated with each of the names, here in sip form alias1@domainAlias, user2@domainA, and user3@domainB. The request or INVITE will be forwarded to each of the second registrars associated with each of the names, here registrar 107 after an intervening loop through registrar 206 for domainAlias and user1, registrar 107 for domainA and user2, and registrar 109 for domainB and user3. The second registrar will include a contact for the associated member, where the contact or contact information is indicative of a location or end point such as host or host address associated with each member, here host1 for user1, host3 for user2 and host4 for user3. The final step in initiating the session with the group is forwarding the request for a session to the location associated with each member of the group.

The names used are preferably indicative of a member or user and a domain or registrar responsible for maintaining contact or end point information for the member all defined according to or compatible with SIP. This method as noted and described allows for forwarding the request for a session or INVITE to an intervening registrar defined by an alias name for one or more of the names indicative of the member and thereafter forwarding the request to the registrar with the contact for that user. Again the method allows for a change in the location or contact associated with a member but does not necessitate a corresponding change in the name associated with the member, thus allowing for mobility of the member or user or a change in location without necessitating a corresponding change to the name for the member.

Note that the SIP protocol provides an alternative method of routing INVITE messages by redirection, rather that by forwarding. With redirection a registrar will retrieve the contact information associated with the destination name included with the INVITE and provide this information to the sender or originator of the INVITE. The sender then will send the INVITE message to the contacts supplied by the registrar. This alternative routing method is not so attractive because it is slower. However, it does support the use of the invention, allowing for mobility of the member or user or a change in location without necessitating a corresponding change to the name for the member.

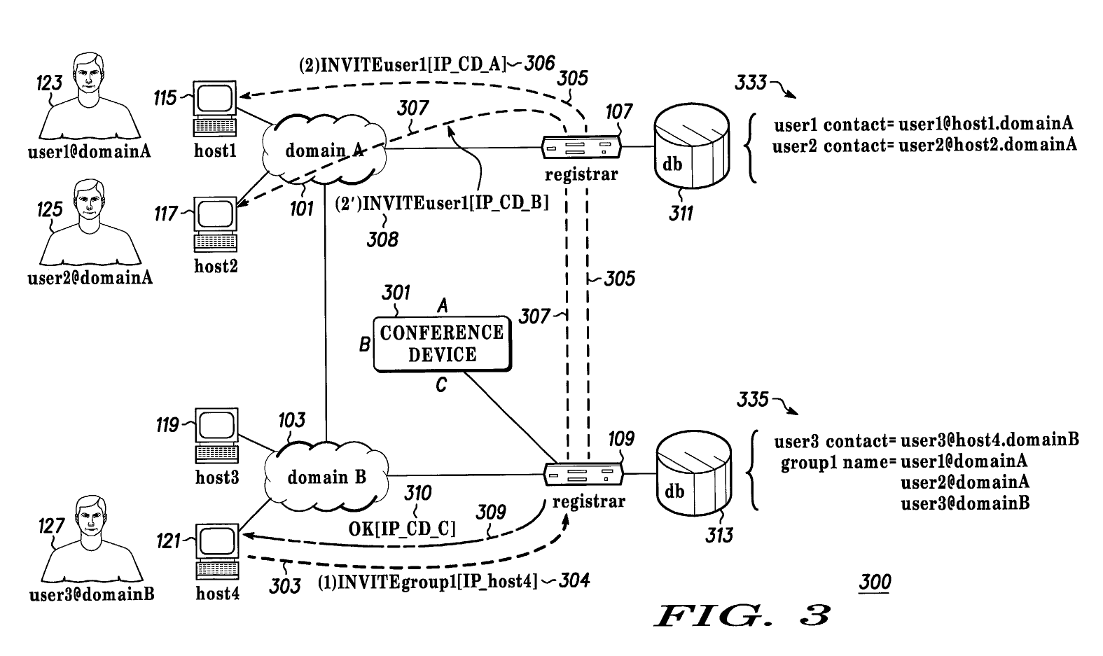

Referring to FIG. 3, a simplified and representative communications system 300 using an embodiment of group management in accordance with the present invention to facilitate setting up a conference call will be described. Much of FIG. 3 is identical or similar to like elements/items from FIGS. 1 and 2 so only the relevant differences will be discussed. Registrar 107 and 109 are shown with database 311 and 313. These databases while functionally similar to the databases of FIGS. 1 and 2 have been given new reference numerals because their, respective, contents 333 and 335 have changed. In relevant part database 311 includes contact or location or end point information for user1 and user2 333. Database 313 includes contact for user3 and names representing the membership of group1, namely user1@domainA, user2@domainA, and user3@domainB. In addition FIG. 3 depicts a conference device 301 coupled to the registrar 109 and having ports A, B, and C. The conference device is a voice packet replication device like those currently being used in conference bridges and in dispatch systems such as those offered by Motorola in dispatch systems known as iDEN dispatch systems. The conference device is used when the group wishes to carry on a session that requires real time or near real time or time critical connectivity such as a voice conference or perhaps interactive video games or the like, typically a session utilizing Real Time Protocol (RTP).

In operation suppose user3 wises to have a conference call with the other members of group1. The FIG. 3 architecture and operation provides an advantageous approach to using a call initiation protocol, such as SIP, to set up a conference call on the conference device 301. This method includes receiving at a registrar 109 from an originator, user3@domainB 127 a request for a call setup, depicted by dashed line 303, INVITE message in SIP parlance, among members of group1, group1 being served by or registered with registrar 109. This INVITE message 304 includes [IP_host4] which represents a conference or voice IP address and port number that user3 anticipates using for the conference call. In some cases the originator will send the address and port in a later setup or transaction message. In any event this conference address and port are usually different than the setup or contact address and port used for signaling to establish the session.

Preferably the registrar will communicate with the conference device 301 and reserve one or more of ports A, B, and C for the group or conference call. The request or INVITE will be forwarded to each of the members of the group, user1and user2, through there respective registrar, here registrar 107, having the location or contact data for each member or user, together with a conference address of the conference device for each of the members, where the conference address is to be used by each of the members for the conference call. The forwarded request to user1 and user2 is, respectively, depicted in FIG. 3 by dashed lines 305 and 307. Note that the INVITE message for user1 306 indicates [IP_CD_A] indicating that user1 should use the conference IP address for the conference device and port A for the conference call. Similarly for user2 the INVITE message 308 indicates [IP_CD_B] indicating that port B on the conference device 301 should be used by user2 for the conference call. Preferably, the conference IP address and port number indicated by the originator, namely [IP_host4], will be removed from the request and replaced or substituted therefore in the forwarded INVITE, as indicated, by the IP address and respective port numbers, A and B, for the conference device. Note that different users may get different IP addresses and port numbers, such as ports A and B, as here. This is often indicative of different communications capabilities for the users and thus for the ports on the conference device. For example users that are equipped to use multicast are likely to all get the same multicast IP address and port number for the conference device.

The users 1 and 2 will respond to the INVITE with an OK message (not shown) for registrar 109 that includes their conference IP addresses and port numbers for the conference call. Registrar 109 will forward or provide the addresses, specifically conference IP address and port numbers for each member of the group, user1, user2, and user3, the originator, to the conference device. The registrar will also send a response, depicted by dashed line 309, to the request or an OK message 310 to the originator, user3, where the response or OK message includes a second conference address [IP_CD_C] of the conference device to be used by user3 for the conference call. This conference address, [IP_CD_A] is a conference or voice IP address, IP_CD, and port number, C. Note in this case where the originator, user3 is a member of the group according to SIP the original INVITE will be forwarded or sent back to this user. If desired this mechanism could be used to communicate the conference device address and port to user3.

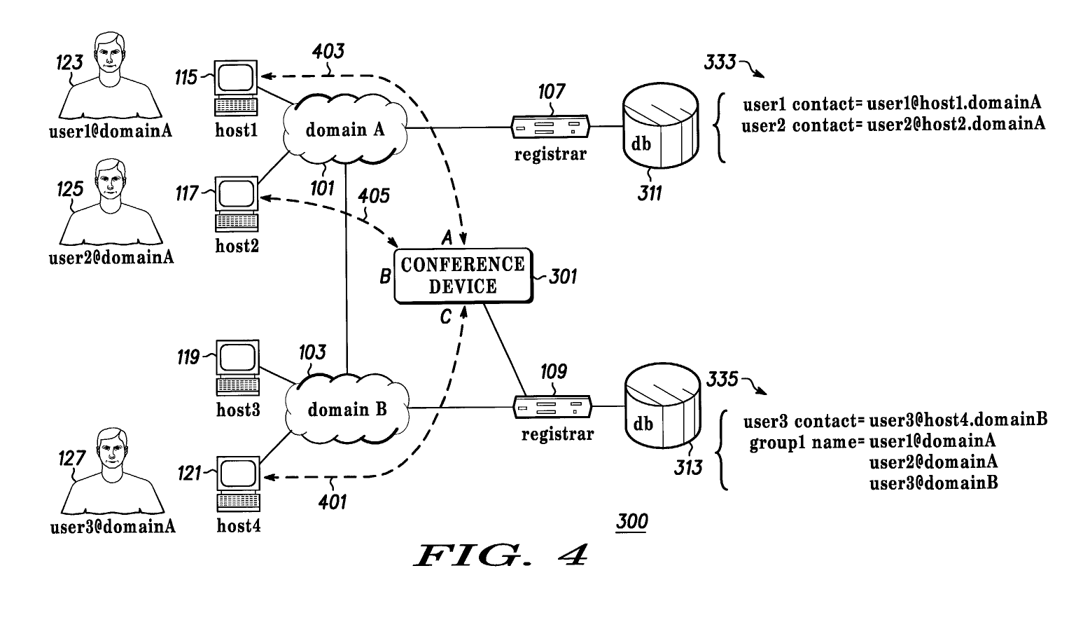

Thereafter as depicted in FIG. 4 all participants in the conference call now use the conference device for session routing after the conference call has been set up. As depicted user3 uses the two way link shown as dashed line 401 to communicate to/from the conference device and user1 and user2, respectively, uses the links, depicted by dash line 403 and 405. This is possible since all parties to the conference call now have the proper conference information, specifically conference IP address and port numbers as a result of the session or call initiation procedures described above. Note; another way to support voice replication in a group call is to use multicast. In networks that support multicast, there is no need for a conference device such as device 301. Either the originating user3@domainB or the registrar would specify the multicast address and port number that is to be used by all participants and include it in the INVITE and OK (response to INVITE) messages as described above.

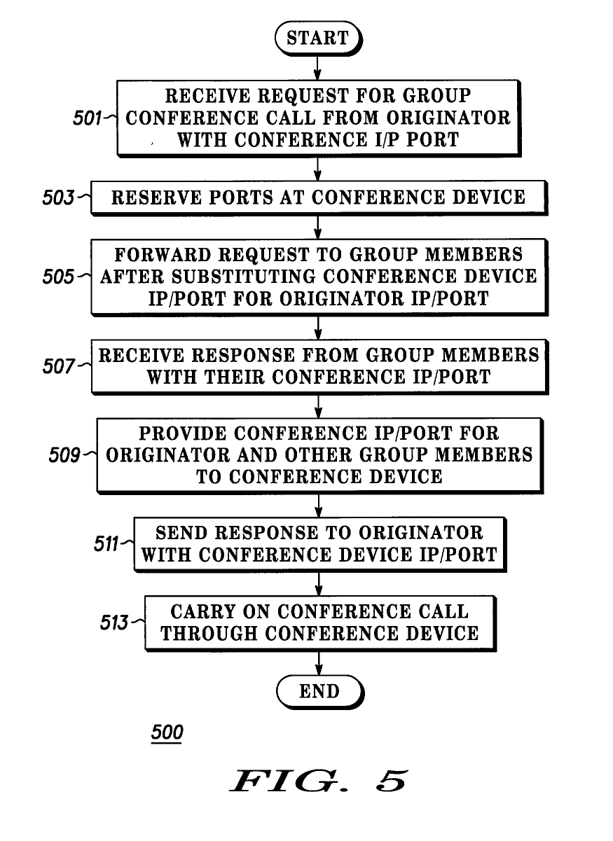

Referring to the FIG. 5 flow chart a method of setting up a conference call will be described. Much of this description is a review of the above discussion and should be read in conjunction therewith. The FIG. 5 method 500 begins at 501 and shows receiving, at a central point or preferably at a registrar from an originator, such as user3, a request for a call setup (preferably along with the originator's conference IP address and port number for the conference), such as an INVITE message in SIP, among members of a group, such as group1, serviced by the registrar. The registrar will include names for each of the members of the group where preferably the names are compatible with SIP and are indicative of each of the members and a member registrar for each of the members that includes a location for each of the members.

At 503 the registrar communicates with the conference device and reserves resources such as port numbers typically according to the various communications capabilities of the respective members of the group. At 505 the request is forwarded to each of the members of the group, via there respective registrar and the location information therein, together with a conference address (IP address and port) of the conference device for each of the members, this conference address is, preferably, substituted for the originators conference address and is to be used by each of the members for the conference call. At 507 responses are received from group members with their conference IP/port information.

At 509 the conference IP/Port information for each member and the originator is provided to the conference device. At 511 the registrar sends a response to the request to the originator, the response including a second conference address of the conference device to be used by the originator for the conference call. At 513 now that all participants including the conference device have all requisite IP addresses and port information all participants in the conference call will use the conference device for the conference call.

The processes, discussed above, and the inventive principles thereof are intended to and will alleviate problems caused by prior art group definition and management. Using these principles of defining groups and managing those groups will simplify modifications of the various group memberships and the network traffic associated with changes to a members location or contact or end point and thus facilitate connectivity for mobile professionals. One of the principles used is using group membership designations that are separate and independent from member contact information so that changes in end point or contact information does not necessitate a change in each groups membership. This dramatically reduces network traffic require for registration activity when a user or member moves from one network domain to another.

Further the individual member does not have to know every group where they may be a member. The risks associated with incorrect registration messages are reduced as the user or member no longer needs to send a new registration message to each registrar serving a group where they are a member when there end point location changes. It becomes practical to have a membership manager or agent maintain group membership and remove that burden completely from the end user. As we have noted the burden with maintaining group membership lists may be further reduced by using an alias SIP name and registrar so that even in a change in home domain, such as a change in service provider will not create a significant burden for group membership management.

Various embodiments of methods, systems, and apparatus for managing group membership so as to facilitate and provide for group calls in an efficient and timely manner have been discussed and described. It is expected that these embodiments or others in accordance with the present invention will have application to many wide area networks that provide for mobility of their user or subscriber devices or units as well as wireless local area networks that are coupled to fixed WANS such as the PSTN or internet. For example wireless systems in which the registrar functionality is embodied in a Home Location Register (HLR) would be ready candidates for using this invention or equivalents thereof. In the HLR one would set up a group name and membership for that group including a plurality of names, each name indicative of a user within the group. Each name can be set up in the form of an International Mobile Subscriber Identity, which resolves into a phone number of the users communication unit. This number would resolve through the use of Global Title Translation, into the HLR registrar of the users communication unit. This disclosure and the inventive principals herein extends to the constituent elements or equipment comprising such systems and specifically the methods employed thereby and therein. Using the inventive principles and concepts disclosed herein advantageously allows or provides for low latency and low network overhead access to contact information for groups of communications units or devices and procedures for maintaining such information which will be beneficial to users and providers a like.

This disclosure is intended to explain how to fashion and use various embodiments in accordance with the invention rather than to limit the true, intended, and fair scope and spirit thereof. The invention is defined solely by the appended claims, as may be amended during the pendency of this application for patent, and all equivalents thereof.

What is claimed is:

1. A method of independently managing membership for a group and mobility for members of that group in a communications system, the method including the steps of:
setting up, in a registrar, a group name and a membership for that group including a plurality of names, each of said plurality of names indicative of a user within that group; and
establishing, separately from said membership, contact information associated with each of said plurality of names.

2. The method of claim 1 wherein said step of setting up a group name and establishing said contact information is compatible with a Session Initiation Protocol (SIP).

3. The method of claim 1 wherein said step of setting up said membership including said plurality of names further includes using a name indicative of said user that points to a registrar where a contact for said user may be found and wherein said register is one of a Session Initiation Protocol registrar and a Home Location Register

4. The method of claim 3 wherein said step of using a name further includes using an alias for said user.

5. The method of claim 1 wherein said step of establishing said contact information allows for a change to said contact information without a corresponding change to said membership information.

6. A method of using a call initiation protocol for initiating a session with members of a group, the method including the steps of:
contacting a first registrar with a request for a session, said first registrar including a plurality of names, each of said names indicative of a member of said group and a second registrar associated with said each of said names;
forwarding said request for a session to said second register associated with said each of said names, said second registrar including a contact for said member, said contact indicative of a location associated with said member; and
forwarding said request for a session to said location associated with said member.

7. The method of claim 6 wherein said each of said names indicates said member and a registrar responsible for maintaining said contact for said member according to a session initiation protocol (SIP).

8. The method of claim 7 wherein said request for a session is an INVITE message defined according to SIP.

9. The method of claim 6 further including a step of forwarding said request for a session to an intervening registrar defined by an alias name for one of said each of said names indicative of said member and thereafter forwarding said request for said session to said second registrar.

10. The method of claim 6 wherein a change in said location associated with said member does not necessitate a corresponding change in said name associated with said member, whereby said member can change said location without necessitating a corresponding change to said plurality of names.

11. A method of using a call initiation protocol to set up a conference call on a conference device, the method including the steps of:
receiving at a registrar from an originator a request for a call setup among members of a group serviced by said registrar;
forwarding said request to a member registrar for each of said members, said member registrar containing a location for said each of said members and forwarding said request to said each of said members of said group together with a conference address of the conference device for said each of said members, said conference address to be used by said each of said members for the conference call; and
sending a response to said request to said originator, said response including a second conference address of the conference device to be used by said originator for the conference call, whereby all participants in the conference call now use the conference device for the conference call.

12. The method of claim 11 wherein said step of forwarding said conference address further includes removing an address for said originator from said request and substituting therefore said conference address of the conference device.

13. The method of claim 12 wherein each of said address, said conference address, and said second conference address is a combination of a conference IP address and a port number.

14. The method of claim 13 wherein said conference address is a plurality of different voice IP addresses and port numbers corresponding to different communications capabilities of different ports at said conference device.

15. The method of claim 13 wherein said address, said conference address, and said second conference address are a multicast address.

16. The method of claim 11 further including a step of providing a first address for said each of said members and a second address for said originator to the conference device.

17. The method of claim 16 wherein said first address and said second address are conference IP addresses and port numbers, respectively, for said each of said members and for said originator.

18. The method of claim 11 wherein said request is an INVITE message as defined by a session initiation protocol (SIP).

19. The method of claim 18 wherein said registrar includes names for each of said members of said group wherein said names are indicative of said each of said members and a member registrar for each of said members that includes a location for said each of said members.

20. The method of claim 11 where said registrar serving said group and said member registrar are each one of a Session Initiation Protocol (SIP) registrar and a Home Location Register (HLR) registrar.
